(19) United States
(12) Patent Application Publication
(10) Pub. No.: US 2023/0250214 A1
(43) Pub. Date: Aug. 10, 2023

(54) Polyurethane Composition for Preparing Composites

(71) Applicant: Covestro Deutschland AG, Leverkusen (DE)

(72) Inventors: Yan Deng, Shanghai (CN); Ruqi Chen, Shanghai (CN); Liguo Liu, Shanghai (CN); Jingmei Liu, Shanghai (CN)

(21) Appl. No.: 18/010,607

(22) PCT Filed: Jun. 25, 2021
(86) PCT No.: PCT/EP2021/067476

§ 371 Date: Dec. 15, 2022

(30) Foreign Application Priority Data
Jun. 30, 2020 (CN) 202010616599.7

(51) Int. Cl. C08G 18/48; C08G 18/76; C08G 18/73; C08G 18/24; C08G 18/67; C08G 18/36; C08K 7/24; C08K 7/14; C08J 5/24; C08G 18/66

(52) U.S. Cl. CPC C08G 18/4816; C08G 18/7671; C08G 18/73; C08G 18/242; C08G 18/672; C08G 18/4837; C08G 18/4829; C08G 18/36; C08K 7/24; C08K 7/14; C08J 5/24; C08G 18/4804; C08G 18/6696; C08J 2375/14

(57) ABSTRACT

The invention relates to a polyurethane composition for preparing composites, a polyurethane composite obtained by the preparation and a method for preparing the polyurethane composite. The polyurethane composition comprises: a) an isocyanate component; b) an isocyanate-reactive component; c) a radical reaction initiator and d) an organometallic catalyst; wherein the hydroxyl value of the component b) isocyanate-reactive component is 200 mgKOH/g to 700 mgKOH/g, and the molar ratio of isocyanate groups to hydroxyl groups of the composition is 0.6 to 1.5. The polyurethane composition of the present invention has the advantages of long pot life and simple operation process. The polyurethane composite comprising the polyurethane resin matrix prepared by the polyurethane composition of the present invention has both excellent weather resistance and mechanical strength.

### CROSS-REFERENCE TO RELATED APPLICATIONS

This application is the United States national phase of International Application No. PCT/EP2021/067476 filed Jun. 25, 2021, and claims priority to Chinese Patent Application No. 202010616599.7 filed Jun. 30, 2020, the disclosures of which are hereby incorporated by reference in their entireties.

### BACKGROUND OF THE INVENTION

### Field of the Invention

The invention relates to a polyurethane composition for preparing composites, a polyurethane composite obtained by the preparation and a method for preparing the polyurethane composite.

### Description of Related Art

The composites composed of a polymer matrix and a fibrous filler are mainly used as lightweight structural components in motor vehicle construction, ship manufacturing, aircraft manufacturing, sports field, construction industry, petroleum industry, and power and energy fields. The polymer matrix of the composite can fix the fibrous filler to ensure the transmission of the load and protect the fibrous filler from the environment. The fibrous filler is used to guide the load. Through a proper combination of polymer matrix and fibrous filler, composites with excellent mechanical strength and physical properties can be obtained.

The polymer matrix in composites is commonly selected from epoxy resins, polyesters, polyurethanes and polyvinyl esters.

Polyurethanes based on an aromatic polyisocyanate are used as the polymer matrix in composites. The composites have good physical properties and thus can be used in indoor applications. However, for outdoor applications, the composites have poor weather resistance and may discolor and tarnish easily. The polymer matrix may easily degrade. Therefore, it is necessary to add a protective coating on the surface of the composites when they are used outdoors. In terms of color, aromatic polyisocyanates produced in industry have often been colored brown. Thus, creating light color or setting a specific hue for polyurethanes based on an aromatic polycyanate as the polymer matrix of the composites is impossible or depends on the specific batch of raw materials. In addition, common aromatic polyisocyanates such as TDI, MDI, and PMDI have too high activity, react quickly during the preparation of polyurethane, and are extremely sensitive to moisture. They will be gelated and cured quickly, making the polyurethanes lose flowability and difficult to be used in subsequent preparation for composites. Thus, the polyurethanes based on an aromatic polyisocyanate as the polymer matrix of composites have a short pot life and show strict requirements on the operation process. Therefore, the industry has been working hard to develop a polyurethane matrix with a long pot life.

Patents CN10290614, CN10321001 and CN103298862 disclose prepregs of storage-stable reactive or highly reactive polyurethane compositions. The polyurethanes in the prepregs are prepared from an aliphatic polyisocyanate blocked using an internal blocking agent (for example in the form of uretdione) and/or an external blocking agent. The disadvantages of the prepregs are high curing temperature and long curing time, making it difficult to be applied to processes that require rapid curing.

Patent CN1221587 discloses an LPA hybrid comprising a compound having at least one ethylenically unsaturated bond and an isocyanate-reactive group as the first component; an ethylenically unsaturated monomer that can be polymerized with the first component by radical polymerization as the second component; a polyisocyanate with an average functionality of at least 1.75 that can be reacted with the first component to provide polyurethanes as the third component; a radical catalyst as the fourth component; and a thermoplastic polymer with a molecular weight of at least 10000 Daltons in an amount of 3 to 20%, relative to the weight of the hybrid. In this method, a lot of components need to be added, and the operation is complicated.

Patent CN103974986 discloses a radically polymerizable resin composition comprising (meth)acryloyl group-containing polyurethanes (I) and (II) having two different structures and a radically polymerizable unsaturated monomer, wherein the structure (I) is generated by the reaction of a polyol having an aliphatic ring structure and an isocyanate having an aliphatic ring structure. The structure (II) is generated by the reaction of a polyether polyol and an isocyanate. This method requires the prior synthesis of the polyurethanes having these two special structures.

CN11023368 describes a polymerizable composition containing components that can be cross-linked either by isocyanurate bonds or by a radical reaction mechanism. The polymerizable composition comprises at least one component having an ethylenic double bond and/or an isocyanate-reactive group, an isocyanate, a trimerization catalyst and a radical initiator. The molar ratio of the isocyanate groups and the isocyanate-reactive groups is at least 2:1. When the reaction components for preparing the polymerizable composition are heated, the trimerization reaction of the isocyanate itself, the addition reaction between the isocyanate groups and the isocyanate-reactive groups, and the polymerization reaction of the ethylenic double bonds initiated by radicals occur simultaneously.

CN110372823 discloses a one-component heat-curable polyurethane composite, comprising a modified polyurethane oligomer, an active compound, a polymerization inhibitor and a radical initiator. The modified polyurethane oligomer is prepared by the reaction of a diisocyanate and a polycaprolactone terminated with single and double bonds. This method requires the prior synthesis of the modified polyurethane oligomer.

CN104045803 discloses a pultruded composite based on an aliphatic polyurethane system, comprising a transparent aliphatic polyisocyanate with a viscosity of not greater than 1000 centipoise at 25° C. and an amine-started polyol with a molecular weight of 150 to 400 and an OH functionality of 3 or more. The aliphatic polyisocyanate and the polyol have high costs of raw materials.

CN105985505 and CN105778005 both describe radically polymerizable compositions consisting of a polyurethane containing double bonds and a reactive diluent based on methacrylates. The isocyanate component in CN105985505 is toluene diisocyanate residue, and that in CN105778005 is diphenylmethane diisocyanate or a prepolymer of diphenylmethane diisocyanate. The compositions are reacted in a two-stage reaction mechanism, and the operation is complicated.

CN104974502 and WO2019/053061 both describe composites obtainable from a reinforcing material and a polyurethane composition. The polyurethane composition consists of at least one aromatic polyisocyanate, an isocyanate-reactive component and a radical initiator. The isocyanate-reactive component is composed of at least one polyol and at least one hydroxyl group-containing methacrylate. The addition reaction between the isocyanate groups and the hydroxyl groups occurs simultaneously with the chain polymerization of the methacrylate initiated by radicals. The polyurethane composition without any catalyst for producing polyurethanes has an increased gel time compared with that of conventional polyurethane systems, but a still shorter gel time compared with that of the epoxy resin and unsaturated resin systems commonly used in the industry. Moreover, the system without any catalyst for producing polyurethanes has reduced reaction speed, and thus is difficult to be applied to processes requiring fast and open operation, such as pultrusion and winding processes.

Therefore, the object of the present invention is to provide a polyurethane composite having both excellent weather resistance and mechanical strength. The polyurethane composition used to provide the polyurethane matrix of the polyurethane composite has the advantages of long pot life and simple operation process.

### SUMMARY OF THE INVENTION

The invention relates to a polyurethane composition for preparing composites, a polyurethane composite obtained by the preparation und use thereof, and a method for preparing the polyurethane composite.

A polyurethane composition for preparing composites according to the present invention comprises:

a) an isocyanate component, the isocyanate component comprising not less than 97.5% by weight of an aliphatic isocyanate and optionally an aromatic isocyanate;

b) an isocyanate-reactive component, comprising:
b1) at least an organic polyol, the amount of the organic polyol being 20% by weight to 80% by weight, relative to the amount of the isocyanate-reactive component as 100% by weight; and
b2) at least a compound having the structure of formula I:

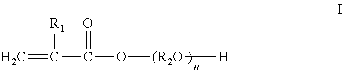

wherein R₁ is selected from hydrogen, methyl or ethyl; R₂ is selected from alkylene groups having 2 to 6 carbon atoms, propane-2,2-bis(4-phenylene), 1,4-xylylene, 1,3-xylylene or 1,2-xylylene; n is an integer of 1 to 6;

c) a radical reaction initiator; and

d) an organometallic catalyst;

wherein the hydroxyl value of the component b) isocyanate-reactive component is 200 mgKOH/g to 700 mgKOH/g, and the molar ratio of isocyanate groups to hydroxyl groups of the composition is 0.6 to 1.5.

An aspect of the present invention is to provide a polyurethane composite comprising a polyurethane resin matrix and a reinforcing material, the polyurethane resin matrix being prepared from the polyurethane composition provided according to the present invention.

Another aspect of the present invention is to provide a method for preparing a polyurethane composite comprising a polyurethane resin matrix and a reinforcing material. The method includes the step of preparing the polyurethane resin matrix under the reaction condition in which the polyurethane composition provided according to the present invention is simultaneously subjected to radical polymerization reaction and to addition polymerization reaction of isocyanate groups and hydroxyl groups.

Yet another aspect of the present invention is to provide use of the polyurethane composite provided according to the present invention for preparing articles.

The polyurethane composition of the present invention has the advantages of long pot life and simple operation process. The polyurethane composite comprising the polyurethane resin matrix prepared from the polyurethane composition of the present invention has both excellent weather resistance and mechanical strength.

### DESCRIPTION OF THE INVENTION

The invention provides a polyurethane composition for preparing composites, comprising:

a) an isocyanate component, the isocyanate component comprising not less than 97.5% by weight of an aliphatic isocyanate and optionally an aromatic isocyanate;

b) an isocyanate-reactive component, comprising:
b1) at least an organic polyol, the amount of the organic polyol being 20% by weight to 80% by weight, relative to the amount of the isocyanate-reactive component as 100% by weight; and
b2) at least a compound having the structure of formula I:

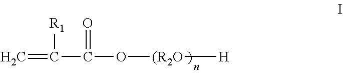

wherein R₁ is selected from hydrogen, methyl or ethyl; R₂ is selected from alkylene groups having 2 to 6 carbon atoms, propane-2,2-bis(4-phenylene), 1,4-xylylene, 1,3-xylylene or 1,2-xylylene; n is an integer of 1 to 6;

c) a radical reaction initiator; and

d) an organometallic catalyst;

wherein the hydroxyl value of the component b) isocyanate-reactive component is 200 mgKOH/g to 700 mgKOH/g, and the molar ratio of isocyanate groups to hydroxyl groups of the composition is 0.6 to 1.5.

The invention also provides a polyurethane composite prepared from the polyurethane composition and use thereof, and a method for preparing the polyurethane composite.

As used herein, the term “gel time” refers to the time from the end of mixing until the polyurethane composition begins to exhibit the gel state. In the present invention, the gel time is measured by a gel time meter.

As used herein, the term “polyurethane polymer” refers to a polyurethaneurea polymer and/or a polyurethane polyurea polymer and/or a polyurea polymer and/or a polythiourethane polymer.

As used herein, the term “isocyanate-reactive group” refers to a group containing zerewitinoff-active hydrogen. The definition of zerewitinoff-active hydrogen is in accordance with that in Rompp's Chemical Dictionary (Rommp Chemie Lexikon), 10th ed., Georg Thieme Verlag Stuttgart, 1996. Typically, a group containing zerewitinoff-active hydrogen in the art is understood to mean hydroxyl group (OH), amino group (NHx) and thiol group (SH).

Polyurethane Composition

The molar ratio of isocyanate groups to hydroxyl groups of the composition is preferably 0.9 to 1.1.

Component a) Isocyanate Component

The isocyanate component contains not less than 97.5% by weight of an aliphatic isocyanate, further preferably not less than 98% by weight of an aliphatic isocyanate, most preferably 100% by weight of an aliphatic isocyanate, relative to the total weight of the isocyanate component.

The isocyanate group content of the component a) isocyanate component is preferably 10% by weight to 61% by weight, further preferably 15% by weight to 50% by weight, most preferably 18% by weight to 40% by weight, relative to the total weight of the component a) isocyanate component.

The aliphatic isocyanate is preferably one or more of the following: unblocked aliphatic diisocyanates, unblocked aliphatic polyisocyanates, unblocked alicyclic diisocyanates, unblocked alicyclic polyisocyanates, and polymers and prepolymers thereof. The polymer may be dimer, trimer, tetramer, pentamer of the isocyanate, or a combination thereof.

The aliphatic isocyanate is further preferably one or more of the following: oligomers of an aliphatic diisocyanate and oligomers of an aliphatic triisocyanate, and most preferably one or more of the following: hexane diisocyanate (hexamethylene-1,6-diisocyanate, HDI), pentane-1,5-diisocyanate, butane-1,4-diisocyanate, 4,4′-methylenebis(cyclohexyl isocyanate), 3,5,5-trimethyl-1-isocyanato-3-isocyanatomethylcyclohexane (isophorone diisocyanate, IPDI), 4-isocyanatomethyl-1,8-octane diisocyanate, 1,3-bis(isocyanatomethyl)benzene (XDI), hydrogenated xylylene diisocyanate and hydrogenated toluene diisocyanate.

The average functionality of the component a) isocyanate component is preferably 2.0 to 3.5, most preferably 2.1 to 3.0.

The viscosity of the component a) isocyanate component is preferably 5 mPa·s to 700 mPa·s, most preferably 10 mPa·s to 300 mPa·s, measured according to DIN 53019-1-3 at 25° C.

The aromatic isocyanate is preferably one or more of the following: 1,2-diisocyanatobenzene, 1,3-diisocyanatobenzene, 1,4-diisocyanatobenzene, 2,4-diisocyanatotoluene, ethylbenzene diisocyanate, isopropylbenzene diisocyanate, toluene diisocyanate, diethylbenzene diisocyanate, diisopropylbenzene diisocyanate, trimethylbenzene triisocyanate, benzene triisocyanate, biphenyl diisocyanate, toluidine diisocyanate, 4,4′-methylene bis(phenylisocyanate), 4,4′-methylene bis(2-methylphenylisocyanate), bibenzyl-4,4′-diisocyanate, bis(isocyanatophenyl) ethylene, bis(isocyanatomethyl) benzene, bis(isocyanatoethyl) benzene, bis(isocyanatopropyl) benzene, α,α,α′,α′-tetramethylxylylene diisocyanate, bis(isocyanatobutyl) benzene, bis(isocyanatomethyl) naphthalene, bis(isocyanatomethylphenyl) ether, bis(isocyanatoethyl) phthalate, 2,6-bis(isocyanatomethyl) furan, 2-isocyanatophenyl-4-isocyanatophenyl sulfide, bis(4-isocyanatophenyl) sulfide, bis(4-isocyanatomethyl phenyl) sulfide, bis(4-isocyanatophenyl) disulfide, bis(2-methyl-5-isocyanatophenyl) disulfide, bis(3-methyl-5-isocyanatophenyl) disulfide, bis(3-methyl-6-isocyanatophenyl) disulfide, bis(4-methyl-5-isocyanatophenyl) disulfide, bis(4-methyloxy-3-isocyanatophenyl) disulfide, 1,2-diisothiocyanatobenzene, 1,3-diisothiocyanatobenzene, 1,4-diisothiocyanatobenzene, 2,4-diisothiocyanatotoluene, 2,5-m-xylene diisothiocyanate, 4,4′-methylene bis(phenylisothiocyanate), 4,4′-methylenebis(2-methylphenylisothiocyanate), 4,4′-methylenebis(3-methylphenylisothiocyanate), 4,4′-diisothiocyanatobenzophenone, 4,4′-diisothiocyanato-3,3′-dimethylbenzophenone, bis(4-isothiocyanatophenyl) ether, 1-isothiocyanato-4-(2-isothiocyanato)sulfonyl]benzene, thiobis(4-isothiocyanatobenzene), sulfonyl (4-isothiocyanatobenzene), hydrogenated toluene diisocyanate (H₆TDI), diphenylmethane diisocyanate and dithiobis(4-isothiocyanatobenzene), most preferably one or more of the following: 1,2-diisocyanatobenzene, 1,3-diisocyanatobenzene, 1,4-diisocyanatobenzene, diphenylmethane diisocyanate, 2,4-diisocyanatotoluene, and derivates thereof having iminooxadiazinedione, isocyanurate, uretdione, carbamate, allophanate, biuret, urea, oxadiazinetrione, oxazolidinone, acyl urea and/or carbodiimide groups.

The amount of the aromatic isocyanate is preferably 0% by weight to 2.5% by weight, further preferably 0% by weight to 2% by weight, relative to the total weight of the isocyanate component. Most preferably, no aromatic isocyanate exists.

Component b) Isocyanate-Reactive Component

The hydroxyl functionality of the component b1) organic polyol is preferably 1.7 to 6, further preferably 1.7 to 4, most preferably 1.7 to 3.3.

The hydroxyl value of the component b1) organic polyol is preferably 20 mgKOH/g to 2000 mgKOH/g, most preferably 20 mgKOH/g to 1200 mgKOH/g. The hydroxyl value is measured by measuring methods well known to those skilled in the art, for example, that disclosed in Houben Weyl, Methoden der Organischen Chemie, vol. XIV/2 Makromolekulare Stoffe, p. 17, Georg Thieme Verlag; Stuttgart 1963. The entire contents of said literature are incorporated herein by reference.

The amount of the component b1) organic polyol is preferably 20% by weight to 80% by weight, most preferably 50% by weight to 60% by weight, relative to the total weight of the component b) isocyanate-reactive component.

The component b1) organic polyol may be organic polyols commonly used in the art for preparing polyurethanes, including but not limited to polyether polyols, polyether carbonate polyols, polyester polyols, polycarbonate diols, polymeric polyols, bio-based polyols, vegetable oil-based polyols or combinations thereof.

The polyether polyols can be prepared by known processes, for example, by reacting an olefin oxide with a starter in the presence of a catalyst. The catalyst for preparing the polyether polyols is preferably one or more of the following: alkali hydroxide, alkali alkoxide, antimony pentachloride and boron fluoride etherate. The olefin oxide for preparing the polyether polyols is preferably one or more of the following: tetrahydrofuran, ethylene oxide, propylene oxide, 1,2-butylene oxide, 2,3-butylene oxide and styrene oxide, most preferably one or more of the following: ethylene oxide and propylene oxide. The starter for preparing the polyether polyols is preferably one or more of the following: polyhydroxy compounds and polyamino compounds. The polyhydroxy compound is preferably one or more of the following: water, ethylene glycol, 1,2-propanediol, 1,3-propanediol, diethylene glycol, trimethylolpropane, glycerin, bisphenol A and bisphenol S. The polyamino compound is preferably one or more of the following: ethylene diamine, propylene diamine, butylene diamine, hexamethylene diamine, diethylene triamine, and toluene diamine. The polyether polyol is most preferably one or more of the following: glycerin-started polyether polyols based on propylene oxide and glycerin-started polyether polyols based on propylene oxide and ethylene oxide.

The polyether carbonate polyol can be prepared by adding carbon dioxide and an alkylene oxide onto the starter containing active hydrogen in the presence of a double metal cyanide catalyst.

The polyester polyol can be prepared by reacting a dicarboxylic acid or dicarboxylic acid anhydride with a polyol. The dicarboxylic acid is preferably an aliphatic carboxylic acid containing 2 to 12 carbon atoms, and most preferably one or more of the following: succinic acid, malonic acid, glutaric acid, adipic acid, suberic acid, azelaic acid, sebacic acid, dodecanedioic acid, maleic acid, fumaric acid, phthalic acid, isophthalic acid and terephthalic acid. The dicarboxylic acid anhydride is preferably one or more of the following: phthalic anhydride, tetrachlorophthalic anhydride, and maleic anhydride. The polyol reacted with the dicarboxylic acid or dicarboxylic acid anhydride is preferably one or more of the following: ethylene glycol, diethylene glycol, 1,2-propanediol, 1,3-propanediol, dipropylene glycol, 1,3-methylpropanediol, 1,4-butanediol, 1,5-pentanediol, 1,6-hexanediol, neopentyl glycol, 1,10-decanediol, glycerin and trimethylolpropane.

The polyester polyol also includes polyester polyols prepared from lactone, preferably ε-caprolactone.

The molecular weight of the polyester polyol is preferably 200 g/mol to 3000 g/mol.

The functionality of the polyester polyol is preferably 1.7 to 6, further preferably 1.7 to 4, and most preferably 1.7 to 3.3.

The polycarbonate diol can be prepared by reacting a diol with a dihydrocarbyl carbonate, diaryl carbonate or phosgene. The diol is preferably one or more of the following: 1,2-propanediol, 1,3-propanediol, 1,4-butanediol, 1,5-pentanediol, 1,6-hexanediol, diethylene glycol and trioxane diol. The dihydrocarbyl carbonate or diaryl carbonate is preferably diphenyl carbonate.

The polymer polyol is preferably a polymer-modified polyether polyol and a bio-based polyol, and most preferably one or more of the following: graft polyether polyols and polyether polyol dispersions.

The graft polyether polyol is preferably one or more of the following: styrene-based graft polyether polyols and acrylonitrile-based graft polyether polyols. The styrene and/or acrylonitrile is preferably prepared by the polymerization of styrene, acrylonitrile, or mixture of styrene and acrylonitrile in situ. In the mixture of styrene and acrylonitrile, the ratio of styrene to acrylonitrile is preferably 90:10 to 10:90, most preferably 70:30 to 30:70.

The dispersed phase of the polyether polyol dispersion is preferably one or more of the following: inorganic fillers, polyureas, polyhydrazides, polyurethanes containing tertiary amino groups in bonded form and melamine. The amount of the dispersed phase (i.e., solid component) of the polyether polyol dispersion is preferably 1% by weight to 50% by weight, further preferably 1% by weight to 45% by weight, most preferably 20% by weight to 45% by weight, relative to the total weight of the polyether polyol dispersion. The hydroxyl value of the polyether polyol dispersion is preferably 20 mgKOH/g to 50 mgKOH/g.

The bio-based polyol is preferably one or more of the following: castor oil and wood tar.

The vegetable oil-based polyol is preferably one or more of the following: vegetable oils, vegetable oil-based polyols, and modified products thereof.

The vegetable oil is preferably one or more of the following: compounds prepared from unsaturated fatty acids and glycerin, oils and fats extracted from fruits, seeds, and germs of plants, and most preferably one or more of the following: peanut oil, soybean oil, linseed oil, castor oil, rapeseed oil and palm oil.

The vegetable oil-based polyol is preferably a polyol started from one or more vegetable oils. The starter for synthesizing vegetable oil-based polyol is preferably one or more of the following: soybean oil, palm oil, peanut oil, rapeseed oi with low erucic acid, and castor oil. Hydroxyl groups can be introduced in the starter of the vegetable oil-based polyol through processes such as cracking, oxidation or transesterification, and then the corresponding vegetable oil-based polyol can be prepared through a process well known to those skilled in the art.

The component b1) organic polyol is most preferably one or more of the following: polyether polyols and bio-based polyols.

When the polyurethane composition comprises two or more organic polyols, the hydroxyl functionality and hydroxyl value of the organic polyols refer to the average functionality and the average hydroxyl value, unless otherwise specified.

When the polyurethane composition comprises two or more organic polyols, it is most preferable that the hydroxyl functionality and hydroxyl value of each organic polyol meet the requirements of the present invention.

The alkylene group having 2 to 6 carbon atoms as R₂ in the component b2) compound having the structure of formula I is preferably selected from ethylene, propylene, butylene, pentylene, 1-methyl-1,2-ethylene, 2-methyl-1,2-ethylene, 1-ethyl-1,2-ethylene, 2-ethyl-1,2-ethylene, 1-methyl-1,3-propylene, 2-methyl-1,3-propylene, 3-methyl-1,3-propylene, 1-ethyl-1,3-propylene, 2-ethyl-1,3-propylene, 3-ethyl-1,3-propylene, 1-methyl-1,4-butylene, 2-methyl-1,4-butylene, 3-methyl-1,4-butylene, 4-methyl-1,4-butylene, propane-2,2-bis(4-phenylene), 1,4-xylylene, 1,3-xylylene or 1,2-xylylene.

The component b2) compound having the structure of formula I is further preferably one or more of the following: hydroxyethyl methacrylate, hydroxypropyl methacrylate, hydroxybutyl methacrylate, hydroxypentyl methacrylate, hydroxyhexyl methacrylate, hydroxyethyl acrylate, hydroxypropyl acrylate and hydroxybutyl acrylate, most preferred hydroxypropyl metacrylate.

The amount of the component b2) compound having the structure of formula I is preferably 20% by weight to 80% by weight, most preferably 40% by weight to 50% by weight, relative to the total weight of the component b) isocyanate-reactive component.

The component b2) compound having the structure of formula I can be prepared by methods commonly used in the art, for example, by esterification of (meth)acrylic anhydride, (meth)acrylic acid or (meth)acryloyl halide with HO—(R₂O)ₙ—H. Those skilled in the art are familiar with these preparation methods, for example, in “Handbook of Raw Materials and Auxiliaries for Polyurethanes”, Chapter III (Liu Yijun, published on Apr. 1, 2005), “Polyurethane Elastomers”, Chapter II (Liu Houjun, published in August 2012). The entire contents of said literatures are incorporated herein by reference.

Component c) radical reaction initiator The amount of the component c) radical reaction initiator is preferably 0.1% by weight to 8% by weight, most preferably 1% by weight to 3% by weight, relative to the total weight of the component b) isocyanate-reactive component.

The radical reaction initiator may be added to the component a) isocyanate component or the component b) isocyanate-reactive component, or both.

The radical reaction initiator is preferably one or more of the following: peroxides, persulfides, peroxycarbonates, perboric acid, azo compounds, and other suitable radical initiator that can initiate the curing of double bond-containing compounds, most preferably one or more of the following: tert-butylperoxy isopropyl carbonate, tert-butylperoxy-3,5,5-trimethylhexanoate, methyl ethyl ketone peroxide, cumene hydroperoxide and benzoyl peroxide.

Component d) Organometallic Catalyst

The amount of the component d) organometallic catalyst is preferably 0.001% by weight to 10% by weight, most preferably 0.1% by weight to 1% by weight, relative to the total weight of the component b) isocyanate-reactive component.

The organometallic catalyst is used to catalyze the reaction of isocyanate groups (NCO) and hydroxyl groups (OH) of the composition.

The organometallic catalyst is preferably one or more of the following: organotin compounds, organobismuth compounds, organozinc compounds and zinc-bismuth composites, and most preferably one or more of the following: tin (II) acetate, tin (II) octoate, tin hexanoate, tin laurate, dibutyl tin oxide, dibutyl tin dichloride, dibutyl tin diacetate, dibutyl tin maleate, dioctyl tin diacetate, bismuth octanoate, bismuth 2-ethylhexanoate, bismuth decanoate, bismuth oleate, bismuth stearate, zinc octoate, zinc 2-ethylhexanoate, zinc decanoate, zinc isobutyrate and composite catalysts having organozinc and organobismuth in weight ratio of 1:1 to 1:8.

Component e) Reaction Accelerator

The polyurethane composition preferably further comprises component e) a reaction accelerator.

The reaction accelerator is preferably one or more of the following: cobalt compounds and amine compounds.

Component f) Additives

The polyurethane polymer preferably further comprises component f) additives.

The additive is preferably one or more of the following: filler, internal mold release agent, flame retardant, anti-smoke agent, dye, pigment, antistatic agent, antioxidant, UV stabilizer, diluent, defoamer, coupling agent, surface wetting agent, leveling agent, water scavenger, catalyst, molecular sieve, thixotropic agent, plasticizer, foaming agent, foam stabilizing agent, foam stabilizer, chelating agent and radical reaction inhibitor.

The additives may optionally be contained in the isocyanate component a) and/or the isocyanate-reactive component b). The additives can also be stored separately. When used to prepare the polyurethane resin matrix of the polyurethane composites, the additives are mixed with the isocyanate component a) and/or the isocyanate-reactive component b) before preparing the matrix.

The filler is preferably one or more of the following: aluminum hydroxide, bentonite, coal ash, wollastonite, perlite powder, floating bead, calcium carbonate, talc powder, mica powder, porcelain clay, fumed silica, expanded microspheres, diatomaceous earth, volcanic ash, barium sulfate, calcium sulfate, glass microspheres, stone powder, wood powder, wood chips, bamboo powder, bamboo chips, rice grains, straw chips, sorghum stem chips, graphite powder, metal powder, recycled powder of thermosetting composites, plastic particle and plastic powder. The glass microspheres can be solid or hollow.

The internal mold release agent may be any conventional mold release agent used to produce polyurethane, preferably one or more of the following: long-chain carboxylic acids, amines of long-chain carboxylic acids, metal salts of long-chain carboxylic acids and polysiloxanes. The long-chain carboxylic acid is preferably a fatty acid, and most preferably stearic acid. The amine of the long-chain carboxylic acid is preferably one or more of the following: stearamide and fatty acid esters. The metal salt of the long-chain carboxylic acid is preferably zinc stearate.

The flame retardant is preferably one or more of the following: triaryl phosphates, trialkyl phosphates, triaryl phosphates with halogen, trialkyl phosphates with halogen, melamine, melamine resin, halogenated paraffin and red phosphorus.

The water scavenger is preferably a molecular sieve.

The defoamer is preferably polydimethylsiloxane.

The coupling agent is used to improve the adhesion between the polyurethane resin matrix and the reinforcing material, preferably one or more of the following: monoethylene oxide and organic amine-functionalized trialkoxysilane.

The thixotropic agent is preferably a fine particle filler, and most preferably one or more of the following: clay and fumed silica.

The chelating agent is preferably one or more of the following: acetylacetone, benzoylacetone, trichloroacetylacetone and ethyl acetoacetate.

The radical reaction inhibitor is preferably one or more of the following: polymerization inhibitors and polymerization retarders, further preferably one or more of the following: phenolic compounds, quinone compounds and hindered amine compounds, most preferably one or more of the following: methylhydroquinone, p-methoxyphenol, benzoquinone, pyiperidine derivatives having one or more methyl groups, and low valence copper ions.

The amount of the additive is not limited as long as it does not affect the performance of the polyurethane compositions of the present invention.

Polyurethane Composite

Preferably, the polyurethane resin matrix is prepared under the reaction condition in which the polyurethane composition is simultaneously subjected to radical polymerization reaction and to addition polymerization reaction of isocyanate groups and hydroxyl groups.

In the addition polymerization of isocyanate groups and hydroxyl groups, the isocyanate groups may be those contained in the isocyanate component a), or those contained in the intermediate of the reaction between the isocyanate component a) and the isocyanate-reactive component b); the hydroxyl groups may be the those contained in the isocyanate-reactive component b) or those contained the intermediate of the reaction between the isocyanate component a) and the isocyanate-reactive component b).

The radical polymerization reaction is an addition polymerization reaction of ethylenic bonds, wherein the ethylenic bonds may be those contained in the component b2), or those contained in the intermediate of the reaction between the component b2) and the isocyanate component a).

The addition polymerization reaction (i.e., the addition polymerization reaction of isocyanate groups and hydroxyl groups) and the radical polymerization reaction are carried out simultaneously.

It is well known to those skilled in the art that appropriate reaction conditions can be selected so that the addition polymerization reaction and the radical polymerization reaction are carried out in sequence. But the polyurethane resin matrix thus prepared has a different structure from that of the polyurethane resin matrix prepared when the addition polymerization reaction and the radical polymerization reaction are carried out simultaneously. Thus, the mechanical strength and processability of these polyurethane composites are different.

The polyurethane composite is preferably prepared by one or more of the following processes: pultrusion molding, winding molding, hand lay-up molding, injection molding, infusion and resin transfer molding, most preferably prepared by vacuum infusion.

The reinforcing material is preferably fibrous, and most preferably one or more of the following: glass fibers, carbon fibers, carbon nanotubes, polyester fibers, natural fibers, basalt fibers, aromatic polyamide fibers, nylon fibers, boron fibers, silicon carbide fibers, asbestos fibers, whiskers, hard particles and metal fibers.

Method for Preparing the Polyurethane Composites

It is well known to those skilled in the art that the use of tin or amine catalysts can promote the addition polymerization of isocyanate groups and hydroxyl groups, the use of heat or accelerators such as aniline accelerators can accelerate the radical polymerization, and the use of cobalt salt accelerators can promote the addition polymerization reaction and the radical polymerization reaction simultaneously. Therefore, those skilled in the art can select appropriate conditions so that the polyurethane composition is simultaneously subjected to radical polymerization reaction and to addition polymerization reaction of isocyanate groups and hydroxyl groups.

The method is preferably one or more of the following: pultrusion molding, winding molding, hand lay-up molding, injection molding, infusion and resin transfer molding, most preferably vacuum infusion.

The content of the reinforcing material is preferably 1% by weight to 90% by weight, further preferably 30% by weight to 85% by weight, most preferably 50% by weight to 80% by weight, relative to the total weight of the polyurethane composite.

The reinforcing material is preferably fibrous, and most preferably one or more of the following: glass fibers, carbon fibers, carbon nanotubes, polyester fibers, natural fibers, basalt fibers, aromatic polyamide fibers, nylon fibers, boron fibers, silicon carbide fibers, asbestos fibers, whiskers, hard particles and metal fibers.

Those skilled in the art are familiar with the operation of the vacuum infusion process for polyurethanes, such as those described in the patent CN1954995A. The entire contents of said literature are incorporated herein by reference.

In the vacuum infusion process, one or more core parts are provided in the mold, and are optionally completely or partially covered with the reinforcing material. Then, a negative pressure is formed in the mold to infuse the polyurethane composition into the mold. Before curing, the polyurethane composition impregnates the reinforcing material fully, and the core parts are fully or partially impregnated with the polyurethane composition. Then, suitable conditions are selected so that the polyurethane composition is subjected to addition polymerization reaction and to radical polymerization reaction simultaneously, thereby curing the polyurethane composition to form the polyurethane resin matrix. In the above vacuum infusion process, the mold may be a mold commonly used in the art. Those skilled in the art may select a suitable mold according to the required performance and size of the final products. When preparing large articles using the vacuum infusion process, in order to ensure sufficient pot life, the polyurethane composition is required to have a sufficiently low viscosity during the infusion process in order to remain well flowable. If the viscosity is higher than 600 mPa·s, it is considered that the viscosity of the polyurethane composition is too high and the composition has a poor flowability and is thus not suitable for the vacuum infusion process.

The core part is used together with the polyurethane resin matrix and the reinforcing material, which is beneficial to the molding of the polyurethane composite and reducing of the weight of the polyurethane composite. Polyurethane composite of the present invention may contain a core part commonly used in the art, including but not limited to polystyrene foams e.g. COMPAXX® foam; PET polyester foams; PMI polyimide foams; polyvinylchloride foams; metal foams e.g. those commercially available from Mitsubishi; balsa wood, etc.

When the hydroxyl functionality of the component b1) organic polyol of the polyurethane composition is preferably 1.7 to 6, further preferably 1.9 to 4.5, still more preferably 2.6 to 4.0, most preferably 2.8 to 3.3, and the hydroxyl value is 150 mgKOH/g to 550 mgKOH/g, further preferably 250 mgKOH/g to 400 mgKOH/g, most preferably 300 mgKOH/g to 370 mgKOH/g. The polyurethane composition is suitable for preparing polyurethane composites by a polyurethane vacuum infusion process. The polyurethane compositions have a longer pot life. The polyurethane composites prepared by the polyurethane vacuum infusion process have good mechanical strength, especially a higher heat deformation temperature, which solves the problem that the pot life of the polyurethane compositions and the heat deformation temperature of the prepared polyurethane composites in the prior art cannot be improved at the same time. These polyurethane composites can be used to prepare wind turbine blades, wind turbine covers, ship blades, ship shells, vehicle interior and exterior trims and body shells, radomes, structural parts for mechanical equipment, decoration parts and structural parts for buildings and bridges or copper clad laminates for electronic and electrical equipment.

The polyurethane composite of the present invention can also be prepared by pultrusion molding process, winding molding process, hand lay-up molding, injection molding process, or a combination thereof. For detailed description of these processes, see “Process and Equipment for Composites”, Chapter 2 and Chapters 6-9 (Liu Xiongya, et. al., 1994, published by Wuhan University of Technology). The entire contents of said literatures are incorporated herein by reference.

When the polyurethane composition comprises a polyether polyol with a functionality of 1.7 to 6, preferably 1.7 to 5.8, most preferably 1.7 to 4.5, and a hydroxyl value of 150 mgKOH/g to 1100 mgKOH/g, preferably 250 mgKOH/g to 550 mgKOH/g, most preferably 300 mgKOH/g to 450 mgKOH/g, the polyurethane composition is suitable for preparing polyurethane composites as fiber reinforced plastic bars replacing such as steel bars or as anchor rods by pultrusion process. As for the specific preparation processes, see CN1562618A, CN1587576A, CN103225369A, U.S. Pat. Nos. 5,650,109A, 5,851,468A, US2002031664A, WO2008128314A1 and U.S. Pat. No. 5,047,104A. The entire contents of said literatures are incorporated herein by reference.

Use

The article is selected from profiles, carriers, structural components for reinforcing pillars or lightweight structural components.

The parts containing the article may be selected from: pipeline covers, trunks, engine hoods, anti-collision parts, bumpers, bulkheads, baffles, pipelines, poles, pressure vessels, storage tanks, wind turbine blades, wind turbine covers, ship blades, ship shells, vehicle interior and exterior trims and body shells, radomes, structural parts and decoration parts for mechanical equipment, buildings and bridges or copper clad laminates for electronic and electrical equipment.

### EXAMPLES

Unless otherwise defined, all technical and scientific terms used herein have the same meaning as commonly understood by those skilled in the art to which the present invention belongs. When the definition of terms in this specification contradicts the meaning generally understood by those skilled in the art to which the present invention belongs, the definition described herein shall apply.

Unless otherwise stated, all numerical values used in the specification and claims to express the amounts of components, reaction conditions, etc. are understood to be modified by the term “about”. Therefore, unless indicated to the contrary, the numerical parameters set forth herein are approximate values that can be varied according to the required performance that needs to be obtained.

Unless otherwise stated, the use of “a”, “an” and “the” in this specification is intended to include “at least one” or “one or more”. For example, “a component” refers to one or more components, so more than one component may be considered and may be employed or used in the implementation of the described embodiments.

As used herein, “and/or” refers to one or all of the mentioned elements.

As used herein, “comprising” and “including” cover the cases where there are only the mentioned elements and the cases where there are other unmentioned elements besides the mentioned elements.

All percentages in the present invention are weight percentages, unless otherwise stated.

The analysis and measurement in the present invention are carried out at 23±2° C. and humidity of 50±5%, unless otherwise stated.

The isocyanate group (NCO) content is determined according to DIN-EN ISO 11909:2007-05. The measured data include free and potentially free NCO content.

Gel time: At 23° C., the fresh polyurethane compositions mixed by Speedmixer were used to measure the gel time using a GTS-THP gel time meter from Paul N. Gardner. When the stirring was started, the timing started immediately. When the gel phenomenon occurred and the torque was too large, the motor stopped working automatically, and the gel time was automatically calculated and displayed. A gel time of greater than or equal to 60 min means that the polyurethane composition is acceptable. The longer the gel time, the longer the pot life of the polyurethane composition, that is, there is less limitation on the operation of polyurethane composition and it is easier to be used in industrial applications.

Curing time: The platform is firstly preheated at 180° C. At 23° C., 10 g of fresh polyurethane composition mixed by Speedmixer were weighed on a metal dish, then placed on the platform at 180° C. The time from the beginning of curing to the complete curing is recorded as the curing time. The longer the curing time, the worse the hardness of the polyurethane compositions. A shorter curing time is beneficial for the process operation in practice. The curing time desired in the present invention is less than 2 minutes.

Viscosity: The DV-II+Pro viscometer from Brookfield was used to measure the viscosity of the fresh polyurethane compositions mixed by Speedmixer at 23° C. according to the DIN EN ISO 3219. When the viscosity of the polyurethane compositions is less than 1000 mPas, it is considered acceptable. A high viscosity is not conducive to the impregnation of the reinforcing material with the polyurethane compositions during the preparation of the polyurethane composite, nor to the application of the composition.

Shore hardness: At room temperature, the cured polyurethane resin matrices were tested for Shore hardness according to DIN EN ISO 868. A polyurethane composition with a Shore hardness of 70 or higher is considered acceptable. The higher the hardness, the better the mechanical strength of the polyurethane resin matrix.

Barcol hardness: At room temperature, the cured polyurethane resin matrices were tested for Barcol hardness according to GB/T 3854-2017.

Yellowing resistance grade: The cured polyurethane resin matrices were tested in QUV/se ultraviolet aging test machine from Q-Lab according to DIN EN ISO 11507 with UVB accelerated aging for 500 hours. The colors before and after aging were compared with those in the standard gray card. The results were expressed as a grade of 1 to 5. Grade 5 means that there is no discernible color change with the naked eyes, indicating that the material is not easy to yellow. Grade 1 means that the color is obviously darker, indicating that the material is easy to yellow. The polyurethane resin matrix having a yellowing resistance grade of greater than or equal to 4 in weather resistance test is considered acceptable. The higher the yellowing resistance grade, the better the weather resistance of the polyurethane resin matrix.

Raw Materials and Reagents

Desmocomp AP200: aliphatic isocyanate with isocyanate group content of 23% by weight and average isocyanate functionality of 3, purchased from Covestro;

Desmodur 1511L: aromatic isocyanate with isocyanate group content of 31.4% by weight and average isocyanate functionality of 2.7, purchased from Covestro;

Castor oil: natural oil-derived polyols, purchased from Sinopharm;

Polyether polyol 1: glycerin-started polyether polyol based on propylene oxide with hydroxyl functionality of 3 and hydroxyl value of 470 mgKOH/g;

Polyether polyol 2: glycerin-started polyether polyol based on propylene oxide with hydroxyl functionality of 3 and hydroxyl value of 245 mgKOH/g;

Polyether polyol 3: glycerin-started polyether polyol based on propylene oxide and ethylene oxide with hydroxyl functionality of 3 and hydroxyl value of 35 mgKOH/g;

Polyether polyol 4: glycerin-started polyether polyol based on propylene oxide and ethylene oxide with hydroxyl functionality of 3 and hydroxyl value of 1120 mgKOH/g;

Hydroxypropyl methacrylate (HPMA): purchased from Heshibi Industrial Chemicals Co., Ltd., with purity of 98% by weight;

Benzoyl peroxide (BPO): purity of 98%, purchased from Sinopharm;

UL 29: organotin catalyst, purchased from Momentive, with trade name of Formrez UL-29;

INT 1940®: mold release agent, purchased from Axel Plastics Research Laboratories, INC.;

BYK 066N: defoamer, purchased from BYK company;

3 Å molecular sieve: purchased from Shanghai Hengye Molecular Sieve Co., Ltd.;

Glass fiber: purchased from Owens Corning, Inc. with trade name of ADVANTEX 366 with 4800 tex.

Method for Preparing Polyurethane Resin Matrices of Examples and Comparative Examples

At 23° C., the compositions were obtained by formulating the components in proportion according to the contents listed in Table 1. The compositions were then placed in Speedmixer DAC 150.1 FVZ from Hauschild and mixed at 2750 rpm for 1 minute. Subsequently, the compositions were poured into a suitable mold and cured in an oven at 160° C. for 10 minutes to obtain the polyurethane resin matrices of Examples and Comparative Examples.

TABLE 1
Components of polyurethane compositions and results of performance tests thereof

| | | | | | | | | Comp. | Comp. | Comp. | Comp. | Comp. | Comp. |
|---|---|---|---|---|---|---|---|---|---|---|---|---|---|
| Formulation | | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 6 |
| Component b) | Castor oil | 15 | 10 | | | | | | | | | | |
| | Polyether | 5 | 18 | 50 | 20 | 40 | 50 | | 50 | | | 50 | 50 |
| | polyol 1 | | | | | | | | | | | | |
| | Polyether | 20 | 15 | | | | | 100 | | | | | |
| | polyol 2 | | | | | | | | | | | | |
| | Polyether | 10 | 17 | | 15 | 20 | | | | 60 | | | |
| | polyol 3 | | | | | | | | | | | | |
| | Polyether | | | | 15 | 0 | | | | | 50 | | |
| | polyol 4 | | | | | | | | | | | | |
| | HPMA | 50 | 40 | 50 | 50 | 40 | 50 | | 50 | 40 | 50 | 50 | 50 |
| Component c) | BPO | 2 | 2 | 2 | 2 | 2 | 2 | 2 | 2 | 2 | 2 | 2 | 2 |
| Component d) | UL29 | 0.6 | 0.6 | 0.6 | 0.6 | 0.6 | 0.6 | 0.6 | 0.6 | 0.6 | 0.6 | 0.6 | |
| Component a) | Desmocomp | 96 | 98 | 141 | 151 | 115 | 141 | 80 | 141 | 57 | 246 | | 141 |
| | AP200 | | | | | | | | | | | | |
| | Desmodur | | | | | | 2.82 | | 4.23 | | | 103 | |
| | 1511L | | | | | | | | | | | | |

| | | | | | | | | | | | | |
|---|---|---|---|---|---|---|---|---|---|---|---|---|
| Hydroxyl value of | 296 | 300 | 432 | 463 | 353 | 432 | 245 | 432 | 177 | 755 | 432 | 432 |
| component b) | | | | | | | | | | | | |
| (mgKOH/g) | | | | | | | | | | | | |

| | |
|---|---|
| Isocyanate | 100 |
| index | |

Results of performance tests

| | | | | | | | | | | | | |
|---|---|---|---|---|---|---|---|---|---|---|---|---|
| Viscosity | 225 | 195 | 182 | 596 | 204 | 178 | 1116 | 178 | 300 | 1006 | 52 | 182 |
| (mpa · s) | | | | | | | | | | | | |
| Gel time | >600 | >600 | >600 | >600 | >600 | 60 | 127 | 15 | >600 | >600 | 2 | >600 |
| (min) | | | | | | | | | | | | |
| Shore D | 76 | 70 | 84 | 84 | 75 | 84 | 35 | 85 | 55 | 87 | 89 | 50 |
| (Shore D) | | | | | | | | | | | | |
| Curing | <2 | <2 | <2 | <2 | <2 | <2 | <2 | <2 | <2 | <2 | <2 | 10 |
| time (min.) | | | | | | | | | | | | |
| Yellowing | 5 | 5 | 5 | 5 | 5 | 4 | 5 | 4 | 5 | 5 | 1 | 5 |
| resistance | | | | | | | | | | | | |
| grade | | | | | | | | | | | | |

The polyurethane compositions of Examples 1 to 6 had suitable viscosity, long gel time, short curing time, high hardness and good weather resistance.

The component b) isocyanate-reactive component of the polyurethane composition of Comparative Example 1 comprised no component b2). The viscosity of the polyurethane composition was high, which is not conducive to the impregnation of the reinforcing material with the polyurethane composition during the preparation of the polyurethane composite. The polyurethane resin matrix prepared by the composition had low hardness and poor mechanical strength.

Compared with that of Example 6, the component a) isocyanate component in the polyurethane composition of Comparative Example 2 comprised aromatic isocyanate in an amount of more than 2.5% by weight, relative to the weight of the component a), and the gel time of the polyurethane composition of Comparative Example 2 was significantly reduced. It was difficult to achieve the pot life required for the process operation in practice. In order to use such a composition, an injection machine will be required, which increases the equipment cost.

The component b) isocyanate-reactive component in the polyurethane composition of Comparative Example 3 had hydroxyl value of 177 mgKOH/g. The polyurethane resin matrix prepared by the polyurethane composition had low hardness, soft hand feeling, and poor mechanical properties.

The component b) isocyanate-reactive component in the polyurethane composition of Comparative Example 4) had hydroxyl value of 755 mgKOH/g. The viscosity of the polyurethane composition was high, which is not conducive to the impregnation of the reinforcing material with the polyurethane composition during the preparation of the polyurethane composite, nor to the application of the composition.

Compared with that of Example 3, the component a) isocyanate component in the polyurethane composition of Comparative Example 5 comprised only aromatic isocyanate and no aliphatic isocyanate. The gel time of the polyurethane composition of Comparative Example 5 was extremely short and it was difficult to achieve the pot life required for the process operation in practice. The polyurethane resin matrix prepared by the polyurethane composition had poor weather resistance.

Compared with that of Example 3, the polyurethane composition of Comparative Example 6 comprised no organometallic catalyst. The catalytic activity of the composition was low, the curing time of the composition was long, and the hardness of the polyurethane resin matrix prepared by the composition was reduced.

### Example 7 Preparation of the Polyurethane Composite by Pultrusion Process

A polyurethane composition was obtained according to the mixing ratio of Example 3 in Table 1, in which 1% by weight of INT 1940® (relative to the total weight of the polyurethane composition of Example 3) was added. The mixture was mixed uniformly. The viscosity was 200 mPa·s and the gel time was greater than 10 hours.

In a commercially available pultrusion equipment, the glass fiber bundles (126 rovings) were oriented and guided through a dipping tank, and the polyurethane composition was poured into the open dipping tank. Then, the glass fibers fully impregnated with the polyurethane composition were directly drawn into a preheated mold by a traction device, the cross section of the mold having a rectangular outline of 110 mm*4.0 mm. Subsequently, the mold was heated in three zones, the temperature zones being H₁=150° C., H₂=190° C., and H₃=210° C. The traction speed was 0.5 m/min and the traction force was about 0.3 t. The prepared polyurethane composite was well impregnated, the traction force of the tractor was stable with fluctuation of less than 10%. The surface of the obtained polyurethane composite was uniform. The glass fiber content was 80% by weight. The Barcol hardness of the composite surface was >50.

### Example 8 Preparation of the Polyurethane Composite by Winding Process

A polyurethane composition was obtained according to the mixing ratio of Example 1 in Table 1, in which 1% by weight of BYK 066N and 2% by weight of 3 Å molecular sieve (relative to the total weight of the polyurethane composition of Example 1) were added. The mixture was mixed uniformly. The viscosity was 300 mPa·s and the gel time was greater than 10 hours.

On a commercially available winding equipment, the polyurethane composition was poured into an open dipping tank. The glass fibers impregnated with the polyurethane composition were repeatedly wound between two ends of a rotating mold core according to the winding process parameters. After the procedure, the mold core with the polyurethane composite wound on the surface was hung on the rotating bracket in a curing furnace, and then the curing furnace was turned on. The rotating bracket drove the mold core to rotate, and at the same time, hot air entered the curing furnace to cure the composite. The curing time was 2 hours, and the curing temperature was 120° C. to 155° C. The obtained polyurethane composite showed good impregnation, uniform surface and had glass fiber content of 65% by weight and Barcol hardness of composite surface of more than 50.

The polyurethane compositions of Examples 7 and 8 were operated in an open dipping tank in a simple way instead of in a closed injection equipment. The obtained composites had excellent performance, i.e. uniform surface, good glass fiber impregnation, high surface hardness, and met the mechanical requirements.

Those skilled in the art can easily understand that the present invention is not limited to the foregoing specific details. The present invention can be implemented in other specific forms without departing from the spirit or main characteristics of the present invention. Therefore, the embodiments should be regarded as illustrative rather than restrictive from any point of view, and the scope of the present invention should be defined by the claims rather than the foregoing descriptions. Thus, any change should be regarded as belonging to the present invention, as long as it falls in the scope of the claims and equivalents thereof.

1. A polyurethane composition for preparing composites, comprising:
a) an isocyanate component, the isocyanate component comprising not less than 97.5% by weight of an aliphatic isocyanate and optionally an aromatic isocyanate;
b) an isocyanate-reactive component, comprising:
b1) at least an organic polyol, an amount of the organic polyol being 20% by weight to 80% by weight, relative to the total weight of the isocyanate-reactive component; and
b2) at least a compound having the structure of formula I: 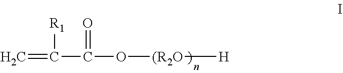
wherein R₁ is selected from hydrogen, methyl or ethyl; R₂ is selected from alkylene groups having 2 to 6 carbon atoms, propane-2,2-bis(4-phenylene), 1,4-xylylene, 1,3-xylylene or 1,2-xylylene; n is an integer of 1 to 6;
c) a radical reaction initiator; and
d) an organometallic catalyst;
wherein a hydroxyl value of the component b) isocyanate-reactive component is 200 mgKOH/g to 700 mgKOH/g, and a molar ratio of isocyanate groups to hydroxyl groups of the composition is 0.6 to 1.5.

2. The polyurethane composition according to claim 1, wherein the component a) aliphatic isocyanate is one or more of the following: unblocked aliphatic diisocyanates, unblocked aliphatic polyisocyanates, unblocked alicyclic diisocyanates, unblocked alicyclic polyisocyanates, and polymers and prepolymers thereof.

3. The polyurethane composition according to claim 1, wherein an isocyanate group content of the component a) isocyanate component is 10% by weight to 61% by weight, relative to the total weight of the component a) isocyanate component.

4. The polyurethane composition according to claim 1, wherein a hydroxyl functionality of the component b1) organic polyol is 1.7 to 6.

5. The polyurethane composition according to claim 1, wherein a hydroxyl value of the component b1) organic polyol is 20 mgKOH/g to 2000 mgKOH/g.

6. The polyurethane composition according to claim 1, wherein the component b2) compound having the structure of formula I is one or more of the following: hydroxyethyl methacrylate, hydroxypropyl methacrylate, hydroxybutyl methacrylate, hydroxypentyl methacrylate, hydroxyhexyl methacrylate, hydroxyethyl acrylate, hydroxypropyl acrylate and hydroxybutyl acrylate.

7. The polyurethane composition according to claim 1, wherein the molar ratio of isocyanate groups to hydroxyl groups of the composition is 0.9 to 1.1.

8. The polyurethane composition according to claim 1, wherein the polyurethane composition further comprises component e) a reaction accelerator, the reaction accelerator being one or more of the following: cobalt compounds and amine compounds.

9. A polyurethane composite comprising a polyurethane resin matrix prepared from the polyurethane composition according to claim 1 and a reinforcing material.

10. The polyurethane composite according to claim 9, wherein the polyurethane resin matrix is prepared under a reaction condition in which the polyurethane composition is simultaneously subjected to radical polymerization reaction and to addition polymerization reaction of isocyanate groups and hydroxyl groups.

11. The polyurethane composite according to claim 9, wherein the polyurethane composite is prepared by one or more of the following: pultrusion molding, winding molding, hand lay-up molding, injection molding, infusion and resin transfer molding, and vacuum infusion.

12. A method for preparing a polyurethane composite comprising a polyurethane resin matrix and a reinforcing material, including preparing the polyurethane resin matrix under a reaction condition in which the polyurethane composition according to claim 1 is simultaneously subjected to radical polymerization reaction and to addition polymerization reaction of isocyanate groups and hydroxyl groups.

13. The method according to claim 12, wherein the method is one or more of the following: pultrusion molding, winding molding, hand lay-up molding, injection molding, infusion and resin transfer molding, and vacuum infusion.

14. A method for preparing an article comprising forming a polyurethane composite according to claim 9.

15. The method according to claim 14, wherein the article is selected from profiles, carriers, structural components for reinforcing pillars or lightweight structural components.
